(19) United States
(12) Patent Application Publication
(10) Pub. No.: US 2021/0089995 A1
(43) Pub. Date: Mar. 25, 2021

(54) Merchant Controls for Preparation Times

(71) Applicant: DOORDASH, INC., San Francisco, CA (US)

(72) Inventors: Jeffrey F. Iacono, San Francisco, CA (US); Jesse L. Reiss, Berkeley, CA (US); Matthias Reichenbach, San Francisco, CA (US)

(21) Appl. No.: 15/389,942

(22) Filed: Dec. 23, 2016

(51) Int. Cl. G06Q 10/06; G06Q 10/08; H04L 29/08

(52) U.S. Cl. CPC G06Q 10/063114; H04L 67/18; G06Q 10/083

(57) ABSTRACT

Techniques to enable a merchant to control preparation times for items that are offered by the merchant are described herein. In some examples, a merchant may indicate a status of demand in preparing orders. For instance, the merchant may indicate that the merchant is associated with more than a threshold amount of preparation activity. When the merchant indicates an increased demand, a preparation time for items that are offered by the merchant may be extended by an amount of time. This extended preparation time may be used to inform customers of delivery times for orders that are being placed or have been placed with the merchant. Additionally, or alternatively, this extended preparation time may be used to inform couriers of pickup times of the items from the merchant for delivery to customers. The extended preparation time may additionally, or alternatively, be used for other purposes.

### BACKGROUND

Merchants often experience fluctuations in the number of orders they receive. In some instances, orders may be placed with a merchant that exceed the merchant's capacity to fulfill those orders. For example, a relatively large number or size of orders may be placed with the same merchant around the same time. This may cause delays in fulfilling the orders and/or cause the merchant to turn down the orders. Furthermore, in instances where courier services are used to deliver the orders, the resources of the courier service may be occupied in rearranging deliveries and/or waiting for pickups (e.g., couriers waiting at the merchants' locations to pickup items).

### BRIEF DESCRIPTION OF THE DRAWINGS

The detailed description is set forth with reference to the accompanying figures, in which the left-most digit of a reference number identifies the figure in which the reference number first appears. The use of the same reference numbers in the same or different figures indicates similar or identical items or features.

FIG. 1 illustrates an example architecture in which the techniques discussed herein may be implemented.

FIG. 2 illustrates example details of a service provider.

FIG. 3 illustrates example details of a merchant device.

FIG. 4 illustrates example details of a courier device.

FIG. 5 illustrates example details of a user device.

FIG. 6 illustrates example merchant and customer interfaces that may be presented to facilitate various functionality described herein.

FIGS. 7A-7B illustrate an example process to transition a merchant to a mode associated with a preparation time.

FIG. 8 illustrates an example process to provide a recommendation regarding transitioning to a mode associated with a preparation time.

FIG. 9 illustrates an example process to inform a courier about a delivery of an order.

FIG. 10 illustrates an example process to enable a merchant to transition to a mode associated with a preparation time.

FIG. 11 illustrates an example process to enable a courier to accept or reject a delivery.

### DETAILED DESCRIPTION

The technology described herein provides a system and environment to enable a merchant to control preparation times for items that are offered by the merchant. In some examples, a merchant may indicate a status of demand in preparing orders. For instance, the merchant may indicate that the merchant is busy preparing order (e.g., associated with more than a threshold amount of preparation activity). When the merchant indicates an increased demand, a preparation time for items that are offered by the merchant may be extended by an amount of time. This extended preparation time may be used to inform customers of extended delivery times for orders that are being placed or have been placed with the merchant. Additionally, or alternatively, this extended preparation time may be used to inform couriers of extended pickup times for items being delivered by the couriers. The extended preparation time may additionally, or alternatively, be used for other purposes. As such, more accurate information about when orders are ready may be provided to customers, couriers, and others.

As one example, a merchant device may display a merchant interface associated with fulfilling orders for customers. The merchant interface may include a control to enable the merchant to indicate how busy the merchant is in preparing orders. For instance, the control may enable the merchant to enter a first mode associated with less than a threshold amount of preparation activity (e.g., the merchant is in a normal state of preparing orders) or a second mode associated with more than the threshold amount of preparation activity (e.g., the merchant is in a busy state). Although any number of modes may be used. If, for example, the merchant selects the control to transition from the first mode to the second mode (to indicate the that merchant is getting busy and will likely experience delays in preparing orders), the merchant device may send a communication to a service provider to set the merchant to the second mode.

The service provider may then transition the merchant from the first mode to the second mode. While in the second mode, the service provider may update a preparation time of orders for the merchant to an extended preparation time. To illustrate, if a pizza merchant transitions from a normal mode associated with preparing pizzas in 10 minutes to a busy mode, the service provider may add 10 additional minutes to the preparation time so that the total preparation time is now 20 minutes. In some instances, the additional time to add to the preparation time associated with the first mode may be specified by the merchant. In other instances, such information may be determined through other means.

In any event, this extended preparation time for the second mode may be used for various purposes. In some instances, the service provider may use the extended preparation time to inform customers of delivery times of items. In particular, the service provider may determine an extended delivery time for items that are offered by the merchant for delivery to customers. The extended delivery time may include both the extended preparation time and a time for a courier to transport an item. The extended delivery time may be made available to customers as they browse items on a customer interface, place orders with the merchant, and so on. To illustrate, if a pizza merchant transitions to a busy mode associated with 10 additional minutes of preparation time, a customer interface may display an estimated delivery time of 30 minutes (20 minutes of preparation time plus 10 minutes of courier time), instead of 20 minutes in a normal mode (10 minutes of preparation time plus 10 minutes of courier time). This may provide the customer with an accurate delivery time for an item.

Further, in some instances the service provider may use the extended preparation time to inform couriers of pickup times of orders. In particular, the service provider may determine an extended pickup time for an item based on the extended preparation time. This extended pickup time may be sent to a courier that is selected to deliver an item for the merchant. In returning to the illustration above where the pizza merchant is set to the busy mode, the service provider may inform a courier to pickup a pizza 10 minutes later than the courier would pickup the pizza if the merchant were in the normal mode. This may allow the courier to arrive at the time when the pizza is ready for delivery, instead of arriving early.

The merchant may remain in the second mode for any length of time. In some instances, a timer may be used to maintain the merchant in the second mode for a period of time. When the period of time expires, an indication may be displayed in the merchant interface to enable the merchant to remain in the second mode, transition back to the first mode, and/or transition to a third mode associated with an even longer preparation time than the second mode. If the merchant requests to remain in the second mode, the timer may be reset and the indication may again be displayed at the expiration of the timer (e.g., the reset period of time). In other instances, the merchant may automatically transition back to the first mode when the period of time expires. In yet other instances, the merchant may interact with the control in the merchant interface at any time to set the merchant back to the first mode (when demand decreases) or to set the merchant to a third mode associated with an even longer preparation time than the second mode (when demand increases even further). As such, the merchant may move from mode to mode as demand changes, so that customers, couriers, and others are accurately informed of a preparation time for items associated with the merchant.

In some examples, the service provider operates a network of courier devices to deliver items to buyers and others. Each of the courier devices may implement a Global Positioning System (GPS) receiver or other location sensor to provide location information to the service provider. The service provider may track the locations of the courier devices to select a courier device for a delivery, send updates regarding delivery of items, or otherwise facilitate delivery of items by couriers. Additionally, or alternatively, the service provider may operate in cooperation with a plurality of merchant devices. Each of the merchant devices may implement a Global Positioning System (GPS) receiver or other location sensor to provide location information to the service provider. The service provider may use the locations of the merchant devices to facilitate delivery of items offered by the merchants and perform other functionality. Further additionally, or alternatively, the service provider may operate in cooperation with a plurality of customer devices. Each of the customer devices may implement a Global Positioning System (GPS) receiver or other location sensor to provide location information to the service provider. The service provider may use the locations of the customer devices to facilitate merchant location pick-up of items offered by the merchants and perform other functionality.

In some examples, the techniques discussed herein allows any person with a mobile device to immediately become a courier, or cease to be a courier, in a courier network that provides delivery services for delivery of items from merchants to buyers. Through the interaction of computing devices, mobile devices, and location sensors, implementations herein can manage an unpredictable sharing ecosystem in which a large number of people are able to start serving as couriers, or cease serving as couriers, as necessary, to accommodate ever changing circumstances and conditions of the merchants, the buyers, the service region, and the couriers themselves. Consequently, the technology disclosed herein may enable efficient crowdsourcing of courier services in an on-demand manner from a varying group of people for providing a delivery service to merchants and buyers, and which can further enable buyers to minimize delivery expenses by combining orders to be delivered by the couriers.

Although the techniques are discussed in many instances in the context of courier deliveries, the techniques may additionally, or alternatively, be used for customer pickup and/or in other contexts. For example, a customer may place an order with a merchant based on an extended pickup time that is expose to the customer through a customer interface. Here, the customer may arrive at the merchant's location to pickup the item, without having used a courier.

This brief introduction is provided for the reader's convenience and is not intended to limit the scope of the claims. Furthermore, the techniques described above and below may be implemented in a number of ways and in a number of contexts. Several example implementations and contexts are provided with reference to the following figures, as described below in more detail. However, the following implementations and contexts are but a few of many.

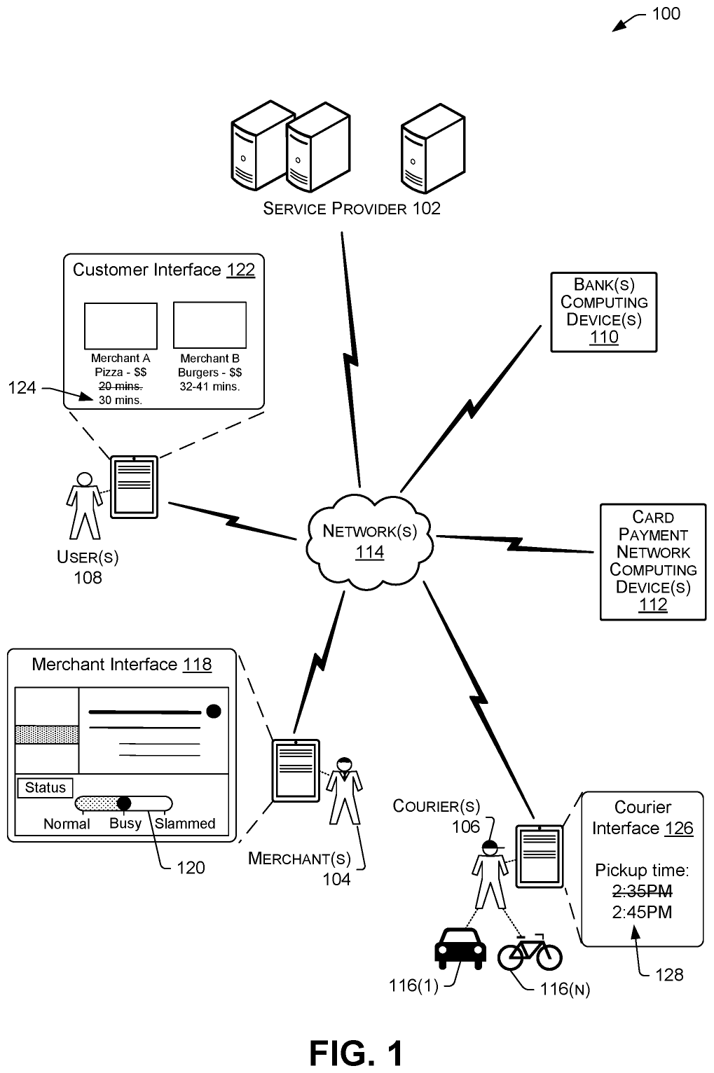

FIG. 1 illustrates an example architecture 100 in which the techniques discussed herein may be implemented. The architecture 100 includes a service provider 102 that communicates with one or more merchants 104 (hereinafter “the merchant 104”), one or more couriers 106 (hereinafter “the courier 106”), one or more users 108 (hereinafter “the user 108”), one or more bank computing devices 110, and/or one or more card payment network computing devices 112 to perform a variety of processing. As one example, the service provider 102 may communicate with the merchant 104 to manage a preparation time and/or delivery time that is exposed to the user 108, the courier 106, and/or others. Further, in some instances the service provider 102 may facilitate transactions between buyers and sellers, which may include communicating with the one or more bank computing devices 110 and/or the one or more card payment network computing devices 112. Each of the merchant 104, the courier 106, and/or the user 108 may be associated with a computing device. As illustrated, any of the computing devices of the architecture 100 may communicate with each other via one or more networks 114. The courier 106 may employ one or more of a plurality of vehicles 116(1)-116(n), such as automobiles, bicycles, scooters, motorcycles, buses, airplanes, helicopters, boats, skateboards, etc. Although in other instances the courier 106 may travel by foot or otherwise without a vehicle.

A merchant may include any business engaged in the offering of goods or services for acquisition by buyers in exchange for compensation received from the buyers. Actions attributed to a merchant may include actions performed by employees or other agents of the merchant and, thus, no distinction is made herein between merchants and their employees unless specifically discussed. Meanwhile, a buyer (e.g., user) may include any entity that acquires goods or services from a merchant, such as by purchasing, renting, leasing, borrowing, licensing or the like. Hereinafter, goods and/or services may be referred to as items. An item may include a finished product, partially finished product, raw material, and so on. Thus, a merchant and a buyer may interact with each other to conduct a transaction in which the buyer acquires one or more items from a merchant, and in return, the buyer provides payment to the merchant.

A courier may include any entity engaged in delivering an item. In one example, a courier may transport an item from a merchant to a user (e.g., upon purchase of the item by the user from the merchant). In another example, a courier may transport an item from a supplier to a merchant. In yet another example, a courier may transport an item between merchants. Some implementations discussed herein enable people to participate as couriers in a type of crowdsourced service economy. Here, essentially any person with a mobile device is able to immediately become a courier, or cease to be a courier, in a courier network that provides delivery services for delivery of items. For example, a user or a merchant may become a courier.

The service provider 102 may be implemented as one or more computing devices, such as servers, laptop computers, desktop computers, and so on. The one or more computing devices may be configured in a cluster, a farm, a data center, a cloud computing environment, or a combination thereof. In one example, the one or more computing devices provide cloud computing resources, including computational resources, storage resources, and the like.

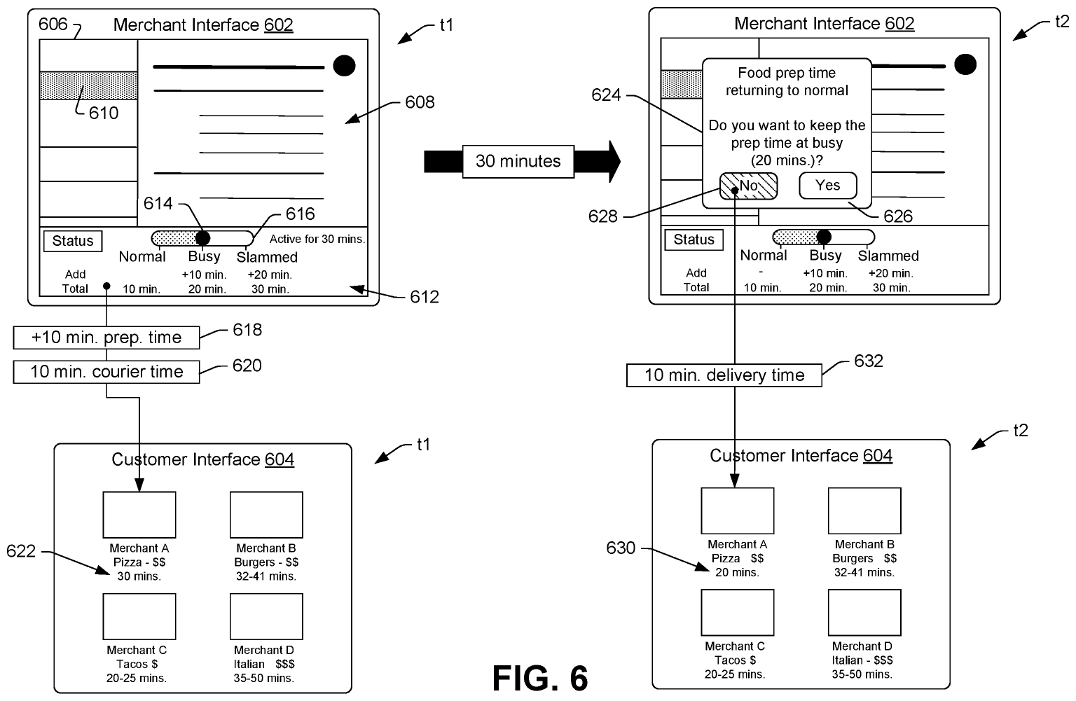

As noted above, the service provider 102 may perform a variety of processing. As illustrated in FIG. 1, the service provider 102 may facilitate a merchant interface 118 to enable merchants to fulfill orders, manage inventory, control preparation times, view courier information, and so on. For example, the merchant interface 118 may indicate orders that are placed with the merchant 104 (including items in those orders), where the orders are in the process of being prepared or delivered, couriers to retrieve the items, times for couriers to pickup the orders for delivery, locations of couriers, how busy the merchant 104 is, and so on. The merchant interface 118 of FIG. 1 includes a status bar 120 for the merchant 104 to enable or disable modes associated with preparation times for items. For example, the merchant 104 may interact with the status bar 120 to select a busy mode associated with more than a threshold amount of preparation activity. In response, the service provider 102 may transition the merchant 104 to the busy mode and update a preparation time associated with the merchant 104. Although three modes are illustrated in FIG. 1 (normal, busy, and slammed), any number of modes may be used. Example merchant interfaces are shown in FIG. 6.

The service provider 102 may also facilitate a customer interface 122 to enable the user 108 to purchase items, manage purchases, monitor deliveries, and so on. For example, the customer interface 122 may display a catalog of items that are offered for acquisition by one or more merchants (merchants A and B in this example). The customer interface 122 may also display other information to enable the user 108 to place an order for an item (e.g., electronic carts, checkout screens, etc.). The customer interface 122 may additionally, or alternatively, enable a customer to track an order that is being delivered to the customer. As illustrated in FIG. 1, the customer interface 122 may provide the user 108 with delivery times for items that are offered from the merchants A and B for delivery. In this example, the merchant A (e.g., the merchant 104) has set its status to the busy mode and the customer interface 122 displays an extended delivery time 124 of 30 minutes. In other words, items that are purchase from merchant A are estimated to be delivered in 30 minutes from the time of placing the order. Although the delivery time associated with the normal mode is illustrated with strikethroughs, in many instances such information may not be provided in the customer interface 122. Example customer interfaces are shown in FIG. 6.

The service provider 102 may also facilitate a courier interface 126 to enable couriers to delivery items to buyers. The courier interface 126 may provide information regarding requests to deliver orders, orders that are assigned to a courier, details regarding an order (e.g., items ordered, price of order, etc.), merchant information (e.g., pickup location, merchant's telephone number, etc.), buyer information (e.g., delivery location, buyer's telephone number, etc.), customer service information (e.g., a telephone number of a customer service agent associated with the service provider 102 that may handle issues with an order), and so on. As noted above, in this example the merchant A (e.g., the merchant 104) has set its status to the busy mode. As such, the courier interface 126 shows an extended pickup time 128 indicating when an order assigned to the courier 106 will be ready for pickup at the merchant 104. In particular, the pickup time 128 is 2:45PM. Although the pickup time associated with the normal mode is illustrated with strikethroughs in FIG. 1, in many instances such information may not be provided in the courier interface 126.

The service provider 102 may also communicate with the one or more card payment network computing devices 112 to conduct a transaction electronically. The one or more card payment network computing devices 112 may be associated with a card payment network (e.g., MasterCard®, VISA®, etc.). The service provider 102 may also communicate with the one or more bank computing devices 110 of one or more banks. For example, the service provider 102 may communicate with an acquiring bank, an issuing bank, and/or a bank maintaining user accounts for electronic payments.

An acquiring bank may be a registered member of a card association (e.g., Visa®, MasterCard®, etc.), and may be part of a card payment network. An issuing bank may issue payment cards to users, and may pay acquiring banks for purchases made by cardholders to which the issuing bank has issued a payment card. Accordingly, in some examples, the computing device(s) of an acquiring bank may be included in the card payment network and may communicate with the computing devices of a card-issuing bank to obtain payment. Further, in some examples, a user may use a debit card instead of a credit card, in which case, the bank computing device(s) of a bank corresponding to the debit card may receive communications regarding a transaction in which the user is participating. Additionally, there may be computing devices of other financial institutions involved in some types of transactions or in alternative system architectures, and thus, the foregoing are merely several examples for discussion purposes.

As noted above, one or more computing devices of the architecture 100 may communicate via the one or more networks 114. The one or more networks 114 may be any type of network, such as a local area network or a wide area network, such as the Internet, and may include a wireless network, such as a cellular network, a local wireless network, such as Wi-Fi and/or close-range wireless communications, such as Bluetooth® and Bluetooth® low energy, a wired network, or any other such network, or any combination thereof. Accordingly, the one or more networks 114 may include both wired and/or wireless communication technologies, including Bluetooth®, Bluetooth® low energy, Wi-Fi, and cellular communication technologies, as well as wired or fiber optic technologies. Components used for such communications can depend at least in part upon the type of network, the environment selected, or both. Consequently, one or more computing devices of the architecture 100 may communicatively couple to the one or more networks 114 in any manner, such as by a wired or wireless connection.

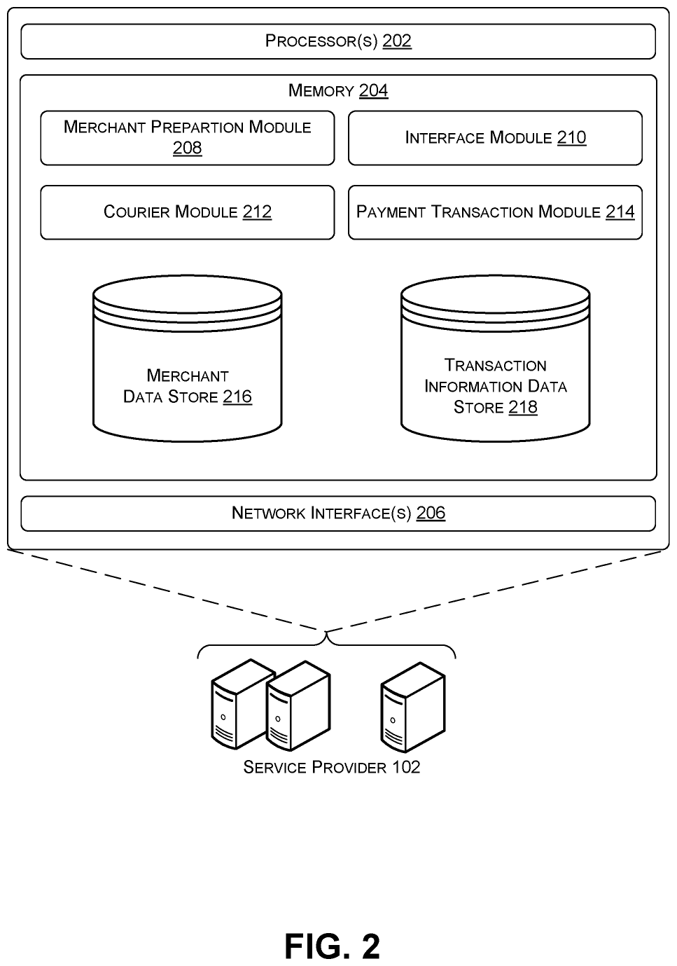

The service provider 102 may also facilitate other functionality as discussed in further detail in reference to FIG. 2. Although various functionality is described herein as being performed through one or more interfaces, the functionality may be implemented through other means, such as in audible manners (e.g., audio output/input to merchants, customers, couriers, etc.), through notifications (e.g., email, text messages, posts, etc.), and so on.

As one example of the techniques discussed herein in the context of the architecture 100 of FIG. 1, the merchant 104 may experience an increase in demand and interact with the merchant interface 118 to select a busy mode. In response, the service provider 102 may set the merchant 104 to the busy mode and update delivery times for the merchant 104 according to the busy mode. Here, the service provider 102 provides the customer interface 122 to the user 108 with the updated delivery time (the extended delivery 124). The user 108 may interact with the customer interface 122 to place an order with the merchant 104 for delivery to a location of the user 108 (e.g., the user's residence). The service provider 102 may notify the merchant 104 that the order has been placed. The service provider 102 may also select the courier 106 to deliver the order to the user 108 based on a location of the courier 106 and/or a location of the merchant 104. The service provider 102 may send a delivery request to the courier 106 requesting that the courier 106 retrieve the order from the merchant 104 at a pickup time and deliver the order to the user 108. Here, the pickup time (when the order is ready for pickup) is based on the merchant 104 being set to the busy mode. In other words, the pickup time associated with a normal mode may be extended. When the order is accepted by the courier 106 for delivery, the service provider 102 may notify the merchant 104 of the courier 106 that will handle the delivery, an estimated pickup time of the order by the courier 106, a location of the courier 106, or other information about the courier 106. The courier 106 may retrieve the order from the merchant 104 and deliver the order to the user 108.

Although many techniques are described herein as being performed by a particular device, any of the techniques may be performed by other devices. For example, techniques described as being performed by the service provider 102, may be performed locally at a computing device of the merchant 104, the courier 106, and/or the user 108.

FIG. 2 illustrates example details of the service provider 102 of FIG. 1. As noted above, the service provider 102 may be implemented as one or more computing devices (e.g., one or more service computing devices). The one or more computing devices may include one or more processors 202, memory 204, and one or more network interfaces 206. The one or more processors 202 may include a central processing unit (CPU), a graphics processing unit (GPU), a microprocessor, a digital signal processor, and so on.

The memory 204 may include software functionality configured as one or more “modules.” The term “module” is intended to represent example divisions of the software for purposes of discussion, and is not intended to represent any type of requirement or required method, manner or necessary organization. Accordingly, while various “modules” are discussed, their functionality and/or similar functionality could be arranged differently (e.g., combined into a fewer number of modules, broken into a larger number of modules, etc.). Further, while certain functions are described herein as being implemented as software modules configured for execution by a processor, in other embodiments, any or all of the functions may be implemented (e.g., performed) in whole or in part by hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), etc.

The memory 204 (as well as all other memory described herein, including memory of a merchant device, a courier device, a user device, and so on) may include one or a combination of computer storage media. Computer storage media includes volatile and non-volatile, removable and non-removable media implemented in any method or technology for storage of information, such as computer readable instructions, data structures, program modules, or other data. Computer storage media includes, but is not limited to, phase change memory (PRAM), static random-access memory (SRAM), dynamic random-access memory (DRAM), other types of random access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transitory medium that can be used to store information for access by a computing device. As defined herein, computer storage media does not include communication media, such as modulated data signals and carrier waves. As such, computer storage media is non-transitory media.

As illustrated, the memory 204 includes a merchant preparation module 208, an interface module 210, a courier module 212, and a payment transaction module 214.

The merchant preparation module 208 may control preparation times for a merchant. In some instances, the merchant preparation module 208 may use a mode scheme to indicate different preparation times needed to fulfill orders. To illustrate, a mode scheme with three modes may include a first mode (e.g., normal mode) associated with less than a first threshold amount of preparation activity, a second mode (e.g., busy mode) associated with more than the first threshold amount of preparation activity and less than a second threshold amount of preparation activity, and a third mode (e.g., slammed mode) associated with more than the second threshold amount of preparation activity. Here, the first mode may be associated with a first preparation time (e.g., 10 minutes), the second mode may be associated with a second preparation time (e.g., 20 minutes) that is more than the first preparation time, and the third mode may be associated with a third preparation time (e.g., 30 minutes) that is more than the second preparation time. The first mode may be the default mode, in many instances. Although three modes are described in this illustration, any number of modes may be used. Further, although the mode scheme may be used, in other instances a more continuous scheme may be used to indicate different preparation times needed to fulfill orders. Here, the merchant preparation module 208 may associate a merchant with any amount of preparation time (e.g., in a more continuous manner), which may not be tied to a specific mode.

In any event, the merchant preparation module 208 may associate a merchant with a preparation time. A preparation time may refer to an amount of time it takes a merchant to prepare an item/order (e.g., 10 minutes) or a time of day/week/month/year at which the item/order is completely or partially prepared (e.g., 2:15PM). To prepare an item/order (also referred to as “preparation activity”), the merchant may perform any number of acts once an order has been placed, such as creating an item (e.g., baking food, manufacturing an item, etc.), packaging an item for delivery (e.g., putting an item in a box for shipment, placing food in a package for delivery, etc.), and so on. The amount of preparation activity may generally represent how much time a merchant is spending preparing orders. This can be based on a number of orders placed, a size of the orders (e.g., a single order includes 10 items), a number of items for the merchant to prepare, how much time is needed to prepare one or more items (e.g., some items may take a long time to prepare). As such, when, for example, a merchant is set to a mode associated with less than a threshold amount of preparation activity, this may indicate that the merchant is, on average, taking less than a threshold amount of time to prepare individual items (e.g., less than 10 minutes on average to prepare an item).

The merchant preparation module 208 may update a preparation time that is associated with a merchant in various manners. In some instances, a merchant may provide input (via a merchant interface) to update a mode associated with the merchant. In response, the merchant preparation module 208 may associate the merchant with the preparation time that is associated with that mode. If, for example, a timer is used to set the merchant to the mode for a period of time, a notification may be presented to the merchant upon expiration of the timer to enable the merchant to remain in the mode or transition to back to an initial mode or another mode. In other instances, the merchant preparation module 208 may automatically transition a merchant from one mode to another. In one illustration, the merchant may have specified in a merchant profile to transition the merchant to a busy mode every Thursday at 11AM. Here, the merchant preparation module 208 may automatically transition the merchant to the busy mode on Thursdays at 11AM. In another illustration, if a merchant is set to a mode for a period of time, the merchant may be automatically set to another mode upon expiration of the period of time (e.g., transition back to an initial mode).

In some instances, the merchant preparation module 208 may provide a recommendation to a merchant to transition to a mode. In one example, the merchant preparation module 208 may provide a recommendation to transition to a busy mode when it is determined that the merchant is experiencing or will experience an increased demand in preparing orders (e.g., demand above a threshold). The increased demand may be based on a number of orders that have been placed with the merchant, a number of orders that are in process of being placed with the merchant (e.g., items that are placed in electronic shopping carts), a conversion rate of orders that are in process of being placed (e.g., a likelihood of an order being placed once the item is in the shopping cart), a size of orders placed with the merchant or in process of being placed (e.g., a number of items per order), a number of orders that the merchant is able to prepare (e.g., 10 orders on average per hour). In another example, the merchant preparation module 208 may provide a recommendation to transition to the busy mode based on the merchant having previously transitioned to the busy mode more than a particular number of times at that time.

In some examples, a recommendation to transition to a mode may request if a merchant would like to be set to the mode for a future time. If, for instance, the merchant preparation module 208 determines that the merchant has transitioned to the busy mode more than a particular number of times on Fridays at 5PM, the recommendation may ask if the merchant would like to automatically set the merchant to the busy mode on Fridays at 5PM. If the merchant so indicates, a merchant profile associated with the merchant may be updated so that the merchant is automatically set to the busy mode on Fridays at 5PM. The recommendation may similarly request when the merchant would like to be set back to a normal mode, and the merchant preparation module 208 may update the merchant profile based on the merchant's input.

The merchant preparation module 208 may also control pickup times and/or delivery times of items. The merchant preparation module 208 may generally use a preparation time associated with a merchant to determine a pickup time and/or a delivery time for the merchant. For example, if a preparation time for a merchant is increased, a pickup time and/or a delivery time for the merchant may be increased to reflect the increased preparation time. Similarly, if a preparation time for a merchant is decreased, a pickup time and/or a delivery time for a merchant may be decreased. The merchant preparation module 208 may use a pickup time to coordinate a delivery of an item by a courier. For example, the merchant preparation module 208 may send a pickup time to the courier module 212 to send a communication to a courier regarding delivery of an item, as discussed in further detail below. A pickup time may also be provided to a merchant and/or customer. Further, the merchant preparation module 208 may use a delivery time to provide customers, couriers, merchants, and other with information regarding delivery. For example, the merchant preparation module 208 may send a delivery time to the interface module 210 to provide a customer with the delivery time of an item offered by the merchant. A delivery time may also be sent to a merchant and/or courier to coordinate delivery of an item.

A pickup time may refer to an amount of time in the future when an order is ready (prepared) for pickup at a merchant (e.g., pickup the order in 30 minutes from now) or a time of day/week/month/year at which the order is ready for pickup (e.g., 3:00PM). In many instances, a pickup time may correspond to a preparation time. For example, if an order will be completely prepared by a merchant at 3PM, the pickup time will be 3PM, since the order will be ready for delivery at that time.

Meanwhile, a delivery time may refer to an amount of time it takes for an order to be delivered to a customer upon placing the order (e.g., 30 minutes) or a time of day/week/month/year at which the order is delivered to the customer (e.g., a drop off time of 3:10PM). As such, a delivery time may include a preparation time for a merchant to prepare an order and/or a time for a courier to transport the order from the merchant to a customer.

When a merchant is transitioned to a mode, the merchant preparation module 208 may generally update a preparation time, pickup time, and/or delivery time associated with a merchant for orders that have not yet been placed with the merchant. For example, in response to updating a delivery time, the merchant preparation module 208 may cause the updated delivery time to be displayed to a customer for an item that has not yet been purchased. That is, a customer browsing items that are offered by the merchant may view the updated delivery time.

Additionally, or alternatively, the merchant preparation module 208 may update existing orders that have already been placed with a merchant. The existing orders may be updated with the same or different preparation time, pickup time, and/or delivery time as the orders that have not been placed. In some instances, a formula is used to calculate the preparation time, pickup time, and/or delivery time for the existing orders. The formula may account for how close in time an order was placed to when a merchant transitioned to a mode. To illustrate, suppose that a first order was placed at 10:10AM and a second order was placed at 10:15AM while a merchant is set to a normal mode associated with a 20 minute delivery time. Also, suppose that the merchant transitions to from the normal mode to a busy mode at 10:20AM, causing the merchant to be associated with a delivery time of 30 minutes. Here, a customer associated with the second order may notified of an updated delivery time of 27 minutes (since this customer was closer to the transition and will likely experience a larger delay in delivery than the first order). Further, a customer associated with the first order may be notified of an updated delivery time of 24 minutes (since this customer was farther from the transition and will likely experience less of a delay in delivery than the second order).

In some instances when determining a delivery time, the merchant preparation module 208 may account for traffic, weather, and/or other environmental conditions. For example, if a preparation time associated with a merchant is extended, creating a pickup time for a courier to be extended into a rush hour traffic (e.g., more than a threshold amount of traffic), the merchant preparation module 208 may add extra time (in addition to the additional preparation time) to the delivery time to account for the rush hour traffic.

In some instances when transitioning a merchant from a mode associated with a relatively high preparation/pickup/delivery time to a mode associated with a relatively low preparation/pickup/delivery time, the merchant preparation module 208 may ease the preparation/pickup/delivery time back down. That is, the transition to the lower mode may occur gradually over a period of time. This may help avoid a sudden increase in demand when back in the lower mode. To illustrate, suppose that a merchant is transitioning from a busy mode associated with a 30 minute delivery time, back to a normal mode associated with a 20 minute delivery time. In one example, the merchant preparation module 208 may incrementally update a preparation time for the merchant back to the 20 minute delivery time associated with the normal mode. Here, the delivery time for the merchant may change at a rate of two minutes per minute, so that the delivery time may change to 28 minutes in response to the transition at minute 0, then 26 minutes at minute 1, then 24 minutes at minute 2, then 22 minutes at minute 3, and then 20 minutes at minute 4.

In another example of easing back down to a lower mode, the merchant preparation module 208 may incrementally make available a preparation/pickup/delivery time associated with the lower mode. Again, suppose that a merchant is transitioning from a busy mode associated with a 30 minute delivery time, back to a normal mode associated with a 20 minute delivery time. Here, the merchant preparation module 208 may make the 20 minute delivery time available to customers over a period of time. For instance, the 20 minute delivery time may be made available to 25% of customers during the first 5 minutes following the transition to the normal mode, 50% of customers for minutes 6-10 following the transition, 75% of customers for minutes 11-15 following the transition, and 100% of customers at minute 16 following the transition.

In yet another example of easing back down to a lower mode, the merchant preparation module 208 may make available a preparation/pickup/delivery time associated with the mode based on a type of customer. Again, suppose that a merchant is transitioning from a busy mode associated with a 30 minute delivery time, back to a normal mode associated with a 20 minute delivery time. In this example, a customer that is associated with a particular characteristic may view the 20 minute delivery time sooner than a customer that is not associated with the particular characteristic. The particular characteristic may indicate that the customer is a relatively loyal customer to the service provider 102 and/or the merchant. The merchant preparation module 208 may generally analyze a purchase history of a customer to identify a customer associated with the particular characteristic. For instance, a customer that is associated with the particular characteristic may be a customer that has purchased more than a threshold number of items from the merchant (or through the service provider 102), has made more than a threshold amount of purchases from the merchant (or through the service provider 102) (e.g., a total dollar amount), and so on.

Although the examples discussed above are in the context of easing back down to a lower mode, any of the techniques may similarly be used when a merchant is transitioned from the lower mode to a higher mode. This may ease a preparation time up to a higher mode.

The merchant preparation module 208 may also manage merchant profiles or other merchant information stored in a merchant data store 216. A merchant profile may include a variety of information about a merchant, such as a merchant's location, costs of items offered by the merchant, a preparation time for each mode, an amount of time to add to a mode, and so on. In some instances, a merchant may use a merchant interface or other means to specify an amount of preparation time associated with a mode, a period of time in which a merchant is set to a mode (e.g., a length of time of a timer), and so on. As such, merchants may customize their modes to provide different preparation times and/or timers.

The merchant preparation module 208 may also generate a report regarding transitioning a merchant to a mode. The report may indicate a number of times merchant input was received to transition the merchant from or to a particular mode, a number of times merchant input was received to maintain the merchant in the particular mode, and/or an identity of an individual (e.g., employee of the merchant) that set or maintained the merchant in the particular mode. The report may be provided to a manager or others associated with the merchant to enable the manage or others to monitor, for example, how often the merchant is being set to a particular mode (e.g., a busy or slammed mode), who is setting the merchant most frequently to the particular mode, and so on.

The interface module 210 may facilitate various interfaces for customers, merchants, and/or couriers. In particular, the interface module 210 may operate in cooperation with the merchant preparation module 208, the courier module 212, and/or the payment transaction module 214 to provide a merchant interface, customer interface, and/or courier interface. For example, the interface module 210 may communicate with the merchant preparation module 208 to receive information regarding preparation times, pickup times, and/or delivery times and provide such information via a merchant interface, customer interface, and/or courier interface. Further, information that is received by the interface module 210 via a merchant interface, customer interface, and/or courier interface may be provided to the merchant preparation module 208, the courier module 212, or the payment transaction module 214 for processing.

The payment transaction module 214 may facilitate transactions between merchants, users, and/or couriers. During a transaction, a user (e.g., customer/buyer) may acquire an item from a merchant by purchasing, renting, leasing, borrowing, licensing, or the like. An item may refer to a good and/or a service offered by merchants. A courier may transport the item from the merchant to the buyer and, in some instances, receive payment from the buyer when delivering the item. The payment transaction module 214 may be configured to enable electronic payments for transactions. In some instances, the service provider 102 may include one or more computing devices that are configured to perform secure electronic financial transactions between merchants and users through, for example, data communicated between a user device and a merchant device. When paying for a transaction, a user can provide the amount of payment that is due to a merchant using cash, check, a payment card, NFC, or by electronic payment. The merchant (or courier) may interact with a device to process the transaction at a point of sale (POS) (e.g., the place where the user meets with the merchant or courier). Further, the transaction may be processed by electronically transferring funds from a financial account associated with a user account for the user to a financial account associated with a merchant account for the merchant. During the transaction, the merchant device can determine and send data describing the transaction, including, for example, appointment data, services related to and/or provided, item(s) being purchased, the amount of the item(s), buyer information, and so forth.

The payment transaction module 214 may store transaction records in a transaction data store 218. A transaction record may include information regarding a time, place and/or an amount of a transaction (e.g., order), information related to the item acquired (e.g., information identifying the item sold), a type of payment being used (e.g., cash, check, payment card, electronic payment, etc.), as well as additional information, such as buyer information. For instance, if a payment card is used, a transaction record can include data stored in the payment card (e.g., Track 1 data (cardholder name, card number and other card information)). In addition, when completing the transaction, a buyer may sometimes provide a receipt email address for receiving a receipt through email. Other examples of data that can be captured for a transaction record include item information (e.g., an itemized listing of the items being acquired, the price being paid for each item, descriptors of the items (size, flavor, color, etc.), etc.), geolocation data indicating a geographic POS location of a particular transaction, online/offline card data, data describing the merchant (e.g., a merchant identifier, a merchant category code (MCC), etc.), data identifying a courier delivering an item, any type of data that is received upon a buyer's authentication into a social network, if any, and various other types of information.

In some implementations, the payment transaction module 214 enables card-less payments (e.g., electronic payments) for transactions between user, merchants, and/or couriers based on interaction of the user with a user device and interaction of the merchant/courier with a device. Accordingly, in some examples a card-less payment transaction may include a transaction conducted at a POS location during which an electronic payment account of the user is charged without the user having to physically present a payment card to the merchant/courier at the POS location. Consequently, the merchant/courier need not receive any details about the financial account of the user for the transaction to be processed. As one example, the electronic payment may be charged to a credit card issuer or credit card number that the user provided when signing up with the service provider 102 for an electronic payment account. As another example, the user may have a quantity of money pre-paid in an account maintained for use in making the electronic payments. Other variations will also be apparent to those of skill in the art having the benefit of the disclosure herein.

The courier module 212 may arrange deliveries for couriers. The courier module 212 may generally select a courier for a delivery and communicate with the courier for the delivery. For example, the courier module 212 may select a courier to transport an item from a seller (e.g., merchant) to a buyer based on a location of the courier relative to the merchant and/or the buyer. The courier module 212 may also provide information to couriers, such as information regarding requests to deliver orders, orders that are assigned to a courier, details regarding an order (e.g., items ordered, price of order, a pickup time at a merchant's location, a delivery time, etc.) merchant information (e.g., pickup location, merchant's telephone number, etc.), buyer information (e.g., delivery location, buyer's telephone number, etc.), customer service information (e.g., a telephone number of a customer service agent associated with the service provider 102 that may handle issues with an order), a route to travel , and so on. As noted above, a pickup time for an item at a merchant's location and/or a delivery time at a customer's location (e.g., drop off time) may be received at the courier module 212 from the merchant preparation module 208. The courier module 212 may cause this information to be sent to a courier.

In some instances, the courier module 212 may track locations of couriers (e.g., when users or merchants act as couriers managed by the service provider 102, when the service provider 102 is associated with a courier service, etc.). To illustrate, the courier module 212 may track locations of the couriers before, during, and after a delivery based on location information received from associated courier devices (e.g., mobile devices). Further, in some instances the courier module 212 may manage the couriers through activation, movement, positioning, and/or deactivation of the couriers. A courier may deliver items to merchants, suppliers, users, and so on.

While FIG. 2 illustrates components and data of the service provider 102 as being present in a single location, these components and data may alternatively be distributed across different computing devices and/or different locations in any manner. Consequently, the functions may be implemented by one or more computing devices, with the various functionality described being distributed in various ways across the different computing devices. Multiple computing devices may be located together or separately, and organized, for example, as virtual servers, server banks, and/or server farms. The described functionality may be provided by the servers of a single entity or enterprise, or may be provided by the servers and/or services of multiple different buyers or enterprises.

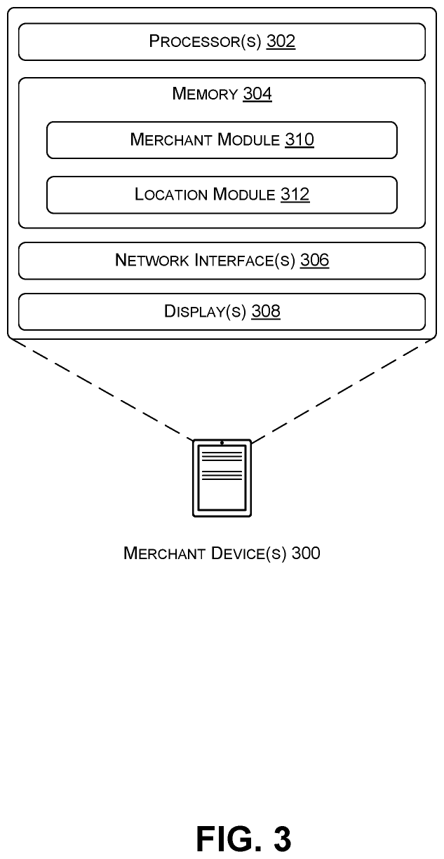

FIG. 3 illustrates example details of a merchant device 300. The merchant device 300 may be employed by the merchant 104 of FIG. 1. The merchant device 300 may be implemented as a laptop computer, a desktop computer, a server, a smart phone, an electronic reader device, a mobile handset, a personal digital assistant (PDA), a portable navigation device, a portable gaming device, a tablet computer, a wearable computer (e.g., a smart watch, an optical head-mounted display (OHMD), etc.), a portable media player, a television, a set-top box, a computer system in an automobile (e.g., navigation system), an appliance, a camera, a robot, a hologram system, a security system, a home-based computer system (e.g., intercom system, home media system, etc.), a projector, an automated teller machine (ATM), and so on. In some instances, the merchant device 300 may be a mobile device.

The merchant device 300 may include one or more processors 302, memory 304, one or more network interfaces 306, and one or more displays 308. The one or more processors 302 may include a central processing unit (CPU), a graphics processing unit (GPU), a microprocessor, a digital signal processor, and so on. The one or more displays 308 may include a touch screen, a Liquid-crystal Display (LCD), a Light-emitting Diode (LED) display, an organic LED display, a plasma display, an electronic paper display, or any other type of technology. Although not illustrated, the merchant device 300 may also include, or be associated with, other components, such as a camera(s), a microphone(s), a speaker(s), a projector(s), a printer(s), and/or a sensor(s). The one or more cameras may include a front facing camera and/or a rear facing camera. The one or more sensors may include an accelerometer, compass, gyroscope, magnetometer, Global Positioning System (GPS), olfactory sensor (e.g., for smell), or other sensor. The merchant device 300 may additionally include, or be associated with, input device(s) such as a keyboard, a mouse, a pen, a voice input device, a touch input device, etc. The memory 304 may include a merchant module 310 and a location module 312.

The merchant module 310 (e.g., merchant application) may perform various processes to assist a merchant in processing transactions with customers, controlling preparation times, managing inventory, communicating with couriers, and so on. The merchant module 310 may provide various interfaces and/or dashboards (e.g., a merchant interface). In one example, the merchant module 310 may facilitate transactions with customers by accepting payment from customers (e.g., via a card reader, NFC connection to a customer device, Bluetooth® connection to customer device, etc.), providing receipts for items (including printing receipts), receiving input from customers for items being acquired by the customers (e.g., confirmation, signature for credit card, etc.), and so on. In another example, the merchant module 310 may provide information regarding items that are ordered for delivery, such as item order details (e.g., a list of items ordered, price, etc.), a delivery time, a courier to deliver order, and so on. In a further example, the merchant module 310 may enable a merchant to manage inventory by informing the merchant of inventory levels (e.g., number of items currently in-stock), order additional inventory, view notifications from the service provider 102 regarding inventory, offer inventory for acquisition to others, seek financing for inventory, and so on. In yet another example, the merchant module 310 may enable a merchant to set a preparation time for items (e.g., set the merchant to a mode associated with preparing items). In some instances, an interface may be provided to a customer to facilitate a transaction (e.g., an interface to confirm payment, provide a signature, etc.). The merchant module 310 may communicate with the service provider 102 to facilitate a variety of functionality (e.g., any components of the service provider 102).

The location module 312 may determine a location of the merchant device 300. In some instances, the location is provided to the service provider 102, or used locally, to facilitate various functions, such as processing of transactions when a customer is located within a particular proximity to the merchant device 300. The location module 312 may determine a geographic location of the merchant device 300 from geolocation techniques (e.g., satellite-based systems—global positioning system (GPS)), cell tower location data, wireless access point location data, wireless beacon location, and so forth. As such, the location module 312 may utilize data from a location sensor of the merchant device 300, such as a GPS receiver or communication interface that can determine (e.g., from cell towers or wireless access points) a geographic location of the merchant device 300.

In some types of businesses, the merchant device 300 may be associated with a store or other place of business of a merchant, and thus, may be a fixed location that typically does not change on a day-to-day basis. In other types of businesses, however, the merchant device 300 may move locations from time to time, such as in the case where the merchant operates a food truck, is a street vendor, a cab driver, etc. or has an otherwise mobile business (e.g., in the case of merchants who sell items at buyer's homes, places of business and so forth).

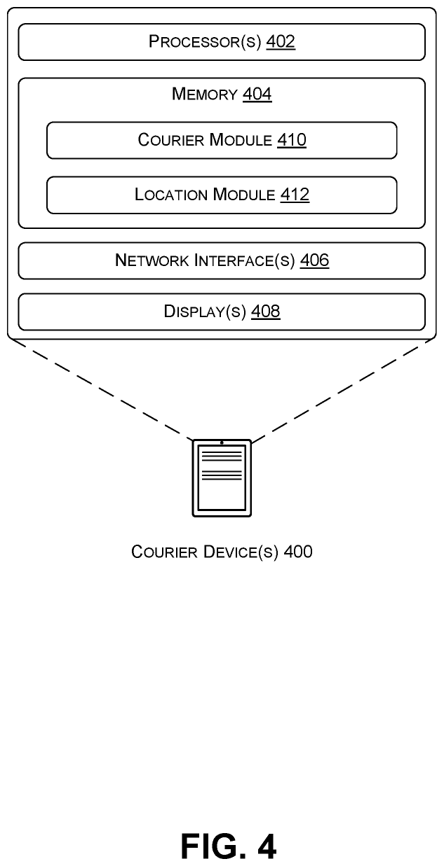

FIG. 4 illustrates example details of a courier device 400. The courier device 400 may be employed by the courier 106 of FIG. 1. The courier device 400 may be implemented as a laptop computer, a desktop computer, a server, a smart phone, an electronic reader device, a mobile handset, a personal digital assistant (PDA), a portable navigation device, a portable gaming device, a tablet computer, a wearable computer (e.g., a smart watch, an optical head-mounted display (OHMD), etc.), a portable media player, a television, a set-top box, a computer system in an automobile (e.g., a navigation system), an appliance, a camera, a robot, a hologram system, a security system, a home-based computer system (e.g., intercom system, home media system, etc.), a projector, an automated teller machine (ATM), and so on. In some instances, the courier device 400 may be a mobile device.

The courier device 400 may include one or more processors 402, memory 404, one or more network interfaces 406, and one or more displays 408. The one or more processors 402 may include a central processing unit (CPU), a graphics processing unit (GPU), a microprocessor, a digital signal processor, and so on. The one or more displays 408 may include a touch screen, a Liquid-crystal Display (LCD), a Light-emitting Diode (LED) display, an organic LED display, a plasma display, an electronic paper display, or any other type of technology. Although not illustrated, the courier device 400 may also include, or be associated with, other components, such as a camera(s), a microphone(s), a speaker(s), a projector(s), a printer(s), and/or a sensor(s). The one or more cameras may include a front facing camera and/or a rear facing camera. The one or more sensors may include an accelerometer, compass, gyroscope, magnetometer, Global Positioning System (GPS), olfactory sensor (e.g., for smell), or other sensor. The courier device 400 may additionally include, or be associated with, input device(s) such as a keyboard, a mouse, a pen, a voice input device, a touch input device, etc. The memory 404 may include a courier module 410 and a location module 412.

The courier module 410 (e.g., courier application) may receive order information from the service provider 102 to provide a courier with information for picking up an order from a merchant's pickup location and/or for delivering the order to a buyer delivery location. The courier module 410 may further enable the courier to respond to the service provider 102 to confirm acceptance of a delivery job. In some instances, the courier module 410 may receive updated delivery information (e.g., pickup time, drop off time, etc.) after an order has been accepted. The updated delivery information may be due to a merchant transitioning from one mode to another mode, causing a preparation time to be updated. The courier module 410 may provide various interfaces and/or dashboards (e.g., a courier interface).

In some cases, the courier module 410 may facilitate the courier to become active or inactive (e.g., in cases where users are used as couriers). For example, the courier application 410 may be periodically pinged by the service provider 102 to determine interest in becoming active and, if so, requesting current location information of the associated courier. A courier who is interested in being activated may respond with location information, while a courier who is not interested in being activated may keep location information private by not responding.

The location module 412 may determine a location of the courier device 400. In some instances, the location is provided to the service provider 102, or used locally, to facilitate various functions. The location module 412 may determine a geographic location of the courier device 400 from geolocation techniques (e.g., satellite-based systems—global positioning system (GPS)), cell tower location data, wireless access point location data, wireless beacon location, and so forth. As such, the location module 412 may utilize data from a location sensor of the courier device 400, such as a GPS receiver or communication interface that can determine (e.g., from cell towers or wireless access points) a geographic location of the courier device 400.

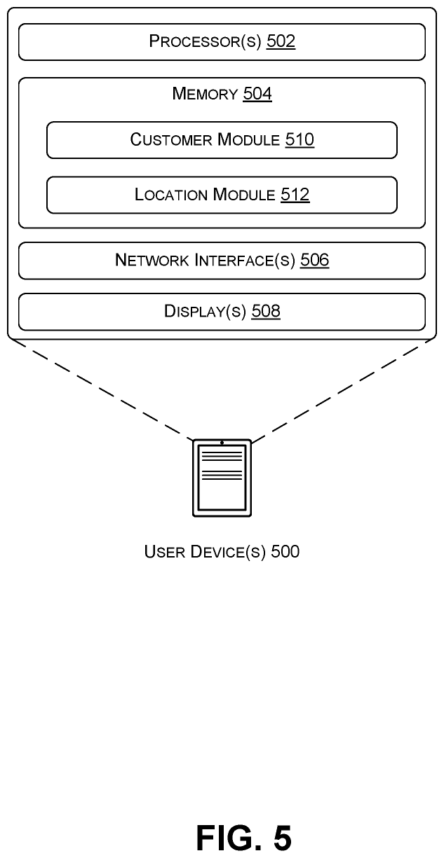

FIG. 5 illustrates example details of a user device 500. The user device 500 may be employed by the user 108 of FIG. 1. The user device 500 may be implemented as a laptop computer, a desktop computer, a server, a smart phone, an electronic reader device, a mobile handset, a personal digital assistant (PDA), a portable navigation device, a portable gaming device, a tablet computer, a wearable computer (e.g., a smart watch, an optical head-mounted display (OHMD), etc.), a portable media player, a television, a set-top box, a computer system in an automobile (e.g., a navigation system), an appliance, a camera, a robot, a hologram system, a security system, a home-based computer system (e.g., intercom system, home media system, etc.), a projector, an automated teller machine (ATM), and so on. In some instances, the user device 500 may be a mobile device.

The user device 500 may include one or more processors 502, memory 504, one or more network interfaces 506, and one or more displays 508. The one or more processors 502 may include a central processing unit (CPU), a graphics processing unit (GPU), a microprocessor, a digital signal processor, and so on. The one or more displays 508 may include a touch screen, a Liquid-crystal Display (LCD), a Light-emitting Diode (LED) display, an organic LED display, a plasma display, an electronic paper display, or any other type of technology. Although not illustrated, the user device 500 may also include, or be associated with, other components, such as a camera(s), a microphone(s), a speaker(s), a projector(s), a printer(s), and/or a sensor(s). The one or more cameras may include a front facing camera and/or a rear facing camera. The one or more sensors may include an accelerometer, compass, gyroscope, magnetometer, Global Positioning System (GPS), olfactory sensor (e.g., for smell), or other sensor. The user device 500 may additionally include, or be associated with, input device(s) such as a keyboard, a mouse, a pen, a voice input device, a touch input device, etc. The memory 504 may include a customer module 510 and a location module 512.

The customer module 510 (e.g., customer application) may provide functionality to enable a user to order an item and/or process a transaction for the item. The customer module 510 may provide various interfaces and/or dashboards (e.g., a customer interface). For example, the customer module 510 may enable a user to view information regarding items offered by a merchant (e.g., delivery times, pricing, etc.), order an item, communicate with a courier, and/or track an order. Additionally, or alternatively, the customer module 510 may enable the user to provide payment for an item (e.g., via a card reader, NFC connection to a merchant device, Bluetooth® connection to a merchant device, etc.), receive receipts for items, and so on. Further, the customer module 510 may enable the user to check in to a merchant to carry out a card-less payment transaction, such as in the case when the user is picking up an item from the merchant (e.g., in a takeout context). Moreover, the customer module 510 may provide a variety of other functionality to order an item and/or process a transaction.

The location module 512 may determine a location of the user device 500. In some instances, the location is provided to the service provider 102, or used locally, to facilitate various functions, such as processing of transactions when a customer is located within a particular proximity to a merchant device or courier device. The location module 512 may determine a geographic location of the user device 500 from geolocation techniques (e.g., satellite-based systems—global positioning system (GPS)), cell tower location data, wireless access point location data, wireless beacon location, and so forth. As such, the location module 512 may utilize data from a location sensor of the user device 500, such as a GPS receiver or communication interface that can determine (e.g., from cell towers or wireless access points) a geographic location of the user device 500.

The merchant module 310, courier module 410, and/or customer module 510 may be implemented in various manners, such as a mobile application, desktop application, a web browser, and so on.

FIG. 6 illustrates example merchant and customer interfaces that may be presented to facilitate various functionality described herein. In particular, FIG. 6 illustrates a merchant interface 602 and a customer interface 604 at time t1 where a merchant transitions from a normal mode to a busy mode and at a time t2 where a merchant returns to the normal mode.

In this example, the merchant interface 602 may provide information regarding orders that are placed with the merchant (e.g., the merchant A). A left portion 606 of the merchant interface 602 may display relatively high level information of all orders (or a particular number of orders) that have been placed with the merchant. Meanwhile, a right portion 608 of the merchant interface 602 may display more detailed information for one or more selected orders. In this example, an order 610 is selected on the left portion 606 of the merchant interface 602 and the right portion 608 is updated to include more detailed information regarding the order. In some instances, the details displayed on the right portion 608 may be more specific than those displayed on the left portion 606.

The merchant interface 602 also includes a status area 612 along a bottom portion of the merchant interface 602 to enable the merchant to set a mode associated with a preparation time. In this example, the merchant may enable one of three modes, a normal mode (default), a busy mode, or a slammed mode. The normal mode may be associated with 10 minutes of total preparation time (with no additional time added), the busy mode may be associated with 20 minutes of total preparation time (including 10 additional minutes with respect to the normal mode), and the slammed mode may be associated with 30 minutes of total preparation time (including 20 additional minutes with respect to the normal mode). Although any number of modes may be used and/or any amount of time may be associated with the modes. The merchant may interface with a visual element 614 on a status bar 616 to select one of the modes. For example, the merchant may slide the visual element 614 to the desired mode. The visual element 614 and/or status bar 616 may be referred to as a control. Here, the merchant has selected the busy mode at time t1.

In response to the merchant selecting the busy mode, the service provider 102 (not illustrated in FIG. 6) may update the preparation time associated with the merchant by adding, at 618, 10 additional minutes to the preparation time associated with the normal mode. This results in an extended preparation time. Further, the service provider 102 may determine an extended delivery time 622 for the merchant by adding, at 620, 10 minutes to the extended preparation time. This may account for an amount of time to it takes a courier to deliver an item (e.g., an estimated amount of time). Here, the total delivery time (the extended delivery time 622) from placing an order to dropping off the order at the customer's location is 30 minutes (10 minutes for preparation +10 additional preparation minutes +10 minutes for delivery by a courier).

In FIG. 6, when the merchant selects the busy mode (at time t1), the service provider 102 sets a timer to 30 minutes. During the 30 minutes, all items (or any number of items) of the merchant may be offered to customers with the extended delivery time 622. In some instances, the merchant may have previously specified the length of time of the timer or may specify the length when enabling the busy mode. In other instances, the length of time of the timer may be determined by the service provider 102 or others.

As illustrated, the customer interface 604 may display, at time t1, the extended delivery time 622 to a customer while browsing items that are offered for acquisition by the merchant A, as well as other merchants. In the example of FIG. 6, the customer interface 604 displays the extended delivery time 622 in a manner that does not indicate that the delivery time is actually extended. In other examples, the customer interface 604 may provide some indication that the delivery time is extended (e.g., display an icon indicator, display the delivery time associated with the normal mode, etc.).

In this example, the customer interface 604 offers items from multiple merchants (i.e., merchants A-D) that have registered with the service provider 102. Here, orders placed through the customer interface 604 may be delivered by a courier service associated with the service provider 102. Although in other instances, the customer interface 604 may display information for a single merchant and/or deliveries may be facilitated by the merchant or others. For example, the merchant may merely use services of the service provider 102 to control preparation times and coordinate its own deliveries for items purchased from the merchant.

At the expiration of the timer (30 minutes after the merchant has enabled the busy mode), the service provider 102 may prompt the merchant to continue in the busy mode or return to the normal mode. In particular, as illustrated at time t2, the merchant interface 602 may display a pop-up window 624 asking the merchant if he would like to remain in the busy mode or return to the normal mode. In other examples, the pop-up window 624 may provide an option to transition to the slammed mode. By selecting a button 626 (the “Yes” button), the merchant may maintain the busy mode for another 30 minutes (e.g., reset the timer to 30 minutes) and the pop-up window 624 may be presented again in 30 minutes. By selecting a button 628 (the “No” button), the merchant may return to the normal mode. In the example of FIG. 6, the merchant selects the button 628, causing the service provider 102 to transition the merchant back to the normal mode.

As illustrated, the delivery time associated with the merchant (merchant A) may return to the normal mode at time t2. That is, the additional 10 minutes that was added to the normal preparation time may be removed. In particular, the service provider 102 may return the merchant to a preparation time of 10 minutes. Further, the service provider 102 may determine a delivery time 630 for the normal mode by adding, at 632, 10 minutes to the preparation time to account for the time it takes a courier to delivery an item. The delivery time 630 may then be displayed, at time t2, through the customer interface 604, as shown in FIG. 6.

In this example, the visual element 614 and the status bar 616 are used in the merchant interface 602 to enable or disable a mode associated with a preparation time. However, any type of user interface elements may be used, such as a dial, input field (e.g., to specify a time), and so on. In some instances, these other types of user interface elements may enable merchants to adjust preparation times on a more granular level (e.g., on a per minute basis).

Although not illustrated in FIG. 6, in some instances the merchant interface 602 may provide a recommendation to enter a mode for future times. For example, if the service provider 102 determines that the merchant has entered the busy mode more than a threshold number of times on Thursdays around 5PM, a recommendation to enable the busy mode on future Thursdays at 5PM may be presented to the merchant. In the context of FIG. 6, the recommendation may be presented at time t1 when the merchant enables the busy mode and/or at time t2 through the pop-up window 624. Although the recommendation may alternatively, or additionally, be presented at other times and/or through other means (e.g., notifications, etc.). If the merchant accepts the recommendation, a profile associated with the merchant may be updated, so that the merchant is automatically transitioned to the busy mode on Thursdays at 5PM.

Further, in some instances the merchant interface 602 may provide a recommendation to enter a mode based on a determination that the merchant is experiencing or will experience a relatively high demand of preparing orders. For example, the service provider 102 may determine a number of orders that are placed with the merchant and/or a number of orders that are in electronic carts and likely to be placed (based on an average conversion rate). If the demand on the merchant is determined to increase above a threshold, the merchant interface 602 may provide a recommendation to enter the busy or slammed mode (e.g., “We expect that you will be busy in the next 2 minutes. Do you want to enter the busy mode?”, “We noticed that you just received a relatively high number of orders. Would you like to enter the slammed mode?”, etc.). The recommendation may be provided to the merchant at any time the determination is made. In some instances, the recommendation is provided via the pop-up window 624 when the merchant is going to decide whether or not to maintain the busy mode (e.g., “It looks like you will be receiving a lot of orders. We recommend that you remain in the busy mode.”).

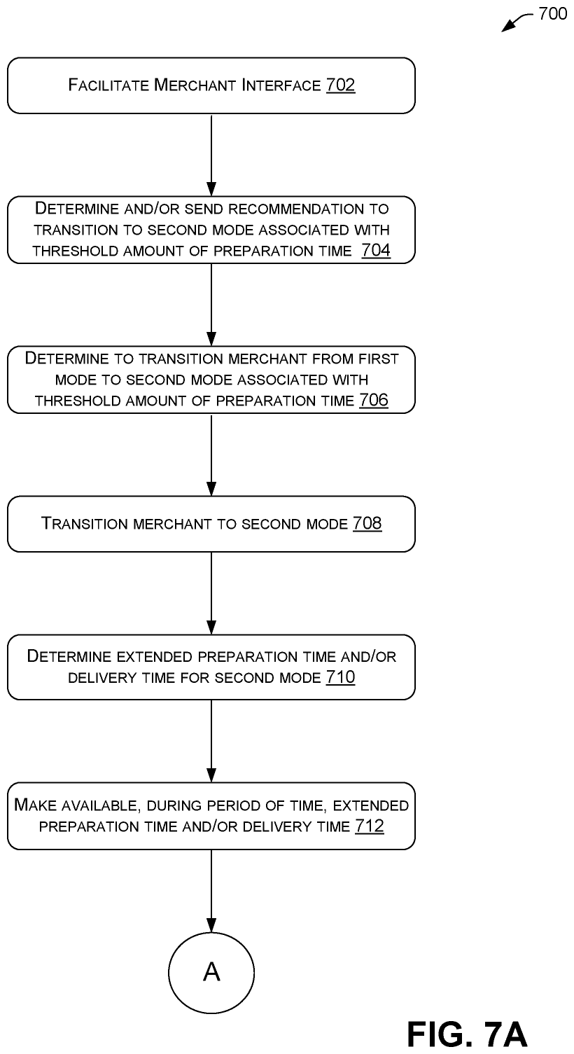

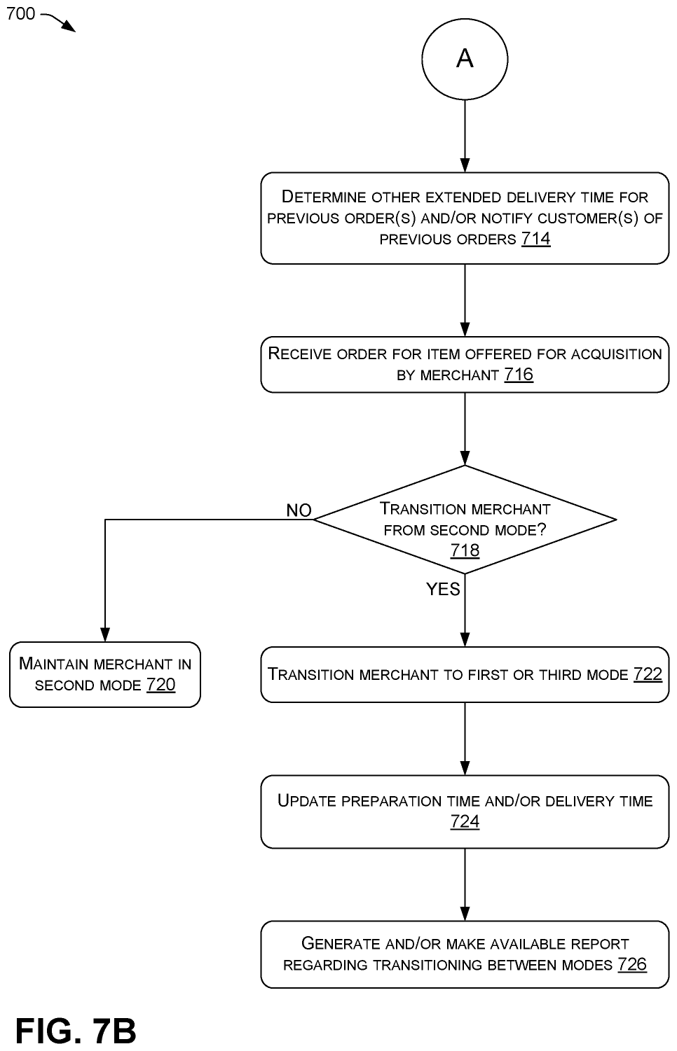

FIGS. 7A, 7B, and 8-11 illustrate example processes 700, 800, 900, 1000, and 1100 for employing the techniques described herein. For ease of illustration the processes 700, 800, 900, 1000, and 1100 may be described as being performed by a computing device described herein, such as the service computing device of the service provider 102, the merchant device 300, the courier device 400, and/or the user device 500. However, the processes 700, 800, 900, 1000, and 1100 may be performed by other devices. Moreover, the devices may be used to perform other processes.

The processes 700, 800, 900, 1000, and 1100 (as well as each process described herein) are illustrated as a logical flow graph, each operation of which represents a sequence of operations that can be implemented in hardware, software, or a combination thereof. In the context of software, the operations represent computer-readable instructions stored on one or more computer-readable storage media that, when executed by one or more processors, perform the recited operations. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process. Further, any number of the described operations may be omitted.

FIGS. 7A-7B illustrates the example process 700 to transition a merchant to a mode associated with a preparation time. For ease of illustration, the process 700 is described as being performed by a service computing device, such as the computing device associated with the service provider 102.

In FIG. 7A, at 702, the service computing device may facilitate a merchant interface. For example, the service computing device may send information to a merchant device to cause the merchant device to display a merchant interface for fulfilling orders. In some instances, the merchant interface may enable a merchant to specify (i) a length of a period of time of a timer associated with setting the merchant to a mode and/or (ii) an amount of time to add to a mode. In response to receiving input from the merchant (e.g., set the timer to 30 minutes; in the busy mode, add 10 minutes to the preparation time associated with the normal mode; etc.), the service computing device may associate a specified length of a timer or an amount of time to add with a merchant profile for the merchant. That is, the merchant profile may be updated to reflect the information specified by the input from the merchant.

At 704, the service computing device may determine and/or send a recommendation to transition from a first mode to a second mode. The first mode may be associated with less than a threshold amount of preparation activity, while the second mode may be associated with more than the threshold amount of preparation activity. In one example, the recommendation may be sent when a number of orders that have been placed with the merchant exceeds a threshold and/or a number of orders that are in process of being placed with the merchant exceeds a threshold. In another example, the recommendation may be sent when a number of orders that the merchant is able to prepare over a period of time is less than a number of order in placed. In yet another example, the recommendation may be sent when the merchant has previously transitioned to the second mode a number of times at the current time. In further examples, any combination of the above examples may be used.

At 706, the service computing device may determine to transition the merchant from the first mode to the second mode. In one example, the service computing device may receive a communication from a merchant device requesting to transition the merchant to the second mode. In another example, the service computing device may access the merchant profile to determine that the merchant has designated a particular time to automatically transition to the second mode. In yet another example, the service computing device may access one or more criteria specified in the merchant profile regarding when to transition to a mode. The one or more criteria may indicate to automatically transition to the second mode when a number of orders that have been placed with the merchant exceeds a threshold and/or a number of orders that are in process of being placed with the merchant exceeds a threshold.

At 708, the service computing device may transition the merchant to the second. As noted above, this transition may occur automatically, based on input received from a merchant, and/or in other manners.

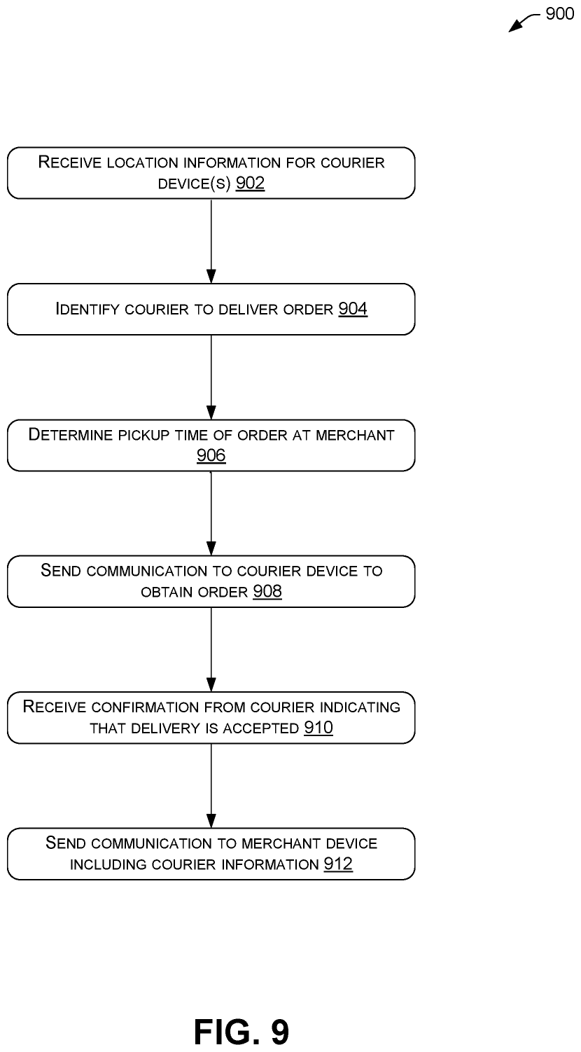

At 710, the service computing device may determine an extended preparation time and/or delivery time for the second mode. For example, to determine an extended preparation time for the second mode, the service provider may add an amount of time to a predetermined preparation time associated with preparing items in the first mode (e.g., adding 10 minutes to the normal 10 minute preparation time). In some instances, the determining may merely include accessing a previously stored preparation time, such as accessing the merchant profile associated with the merchant or a more generic merchant profile associated with multiple merchants (e.g., all merchants, a group of merchants associated with a particular category, etc.). To determine the extended delivery time, the service computing device may add an amount of time for a courier to make a delivery to the extended preparation time. In some instances, an extended pickup time may also be determined at 710. An example determination of an extended pickup time is discussed in below in reference to FIG. 9.

At 712, the service computing device may make available, during a period of time, the extended preparation time and/or delivery time. For example, the extended delivery time may be made available to a customer via a customer interface associated with acquiring items from the merchant. The extended preparation time and/or delivery time may be made available for the period of time (which may be associated with a timer). In one example, the length of the period of time may be a predetermined length. In another example, the length may be specified in the merchant profile. In yet another example, the length may be based on previous merchant input to maintain the merchant in the second mode. To illustrate, if the merchant frequently (more than a threshold) maintains the merchant in the second mode for 2 hours, the length of the period of time may be updated to 2 hours. Here, when the merchant transitions to the second mode the next time, the merchant will use a 2-hour timer.

In FIG. 7B, at 714, the service provider may determine another extended delivery time for a previous order(s) and/or notify a customer(s) of the previous order about the other extended delivery time. This may allow previous orders that are in process of being delivered to a customer to be updated with accurate information regarding delivery. In some instances, the other extended delivery time for the previous order is the same as the extended delivery time determined at 710. In other instances, the other extended delivery time for the previous order is based on how close in time the previous order was placed with respect to transitioning to the merchant to the second mode. The service provider may notify the customer of the previous order by sending a communication to a customer device associated with the customer indicating that the previous order will be delivered according to the other extended delivery time.

At 716, the service computing device may receive an order for an item that is offered for acquisition by the merchant.

At 718, the service computing device may determine whether or not to transition from the second mode. In one example, the service computing device may receive a communication from the merchant device indicating whether or not to maintain the second mode. In another example, the service computing device may determine to automatically transition back to the first mode when the period of time expires, a number of orders placed with the merchant drops below a threshold, a number of orders in process of being placed with the merchant drops below the threshold, and so on.

In response to determining to not transition the merchant from the second mode (the “NO” path), the service computing device may maintain the merchant in the second mode, at 720. This may include extending for another period of time.

In response to determining to transition the merchant from the second mode (the “YES” path), the service computing device may transition the merchant to the first mode or a third mode, at 722.

At 724, the service computing device may update the preparation time and/or delivery time associated with the merchant. That is, the service computing device may change the preparation time and/or delivery time to a preparation time and/or delivery time associated with the first/third mode. In some examples, this may occur in one instance. In other examples, this may occur gradually, such as by incrementally updating the preparation time back to the preparation time associated with the first mode, incrementally making available the updated delivery time to customers, making available the updated delivery time based on a purchase history of a customer, and so on. In some instances, the service computing device may also update a pickup time for the merchant at 724.

At 726, the service computing device may generate and/or make available a report regarding transitioning between states. The report may provide various information regarding transitioning between modes. For example, the report may indicate a number of times merchant input was received to set the merchant to the second mode, a number of times merchant input was received to maintain the merchant in the second mode, or an identity of an employee of the merchant that set or maintained the merchant in the second mode. The report may be made available to various parties, such as manages of the merchant, executives of the merchant, and so on.

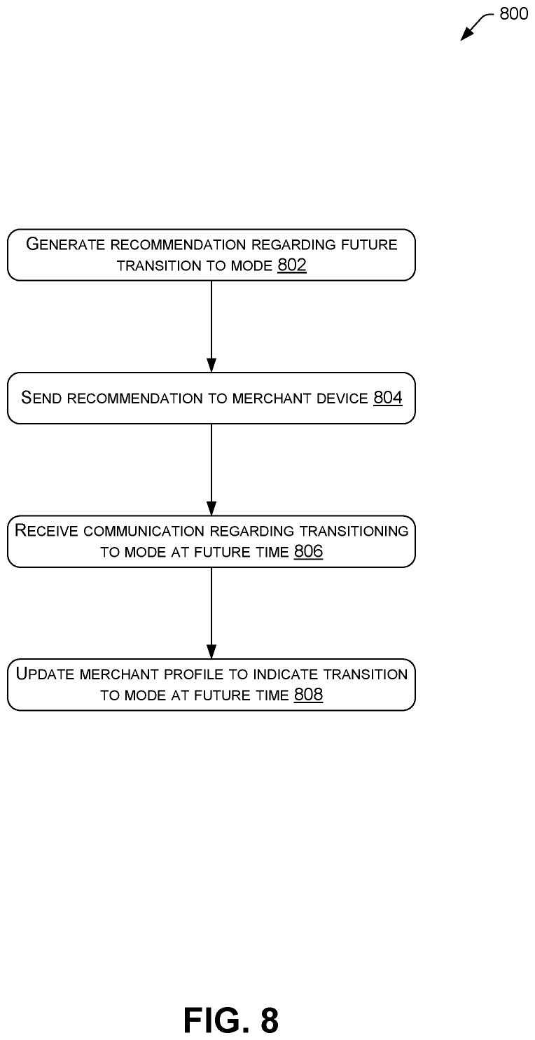

FIG. 8 illustrates the example process 800 to provide a recommendation regarding transitioning to a mode associated with a preparation time. For ease of illustration, the process 800 is described as being performed by a service computing device, such as the computing device associated with the service provider 102.

At 802, the service computing device may generate a recommendation regarding a future transition to a mode. The recommendation may be generated based on a number of times the merchant has been previously set to or maintained in the second mode. The recommendation may suggest that the merchant transition to the second mode at a particular time in the future (e.g., “Based on your transition history, we suggest that you enable a setting to automatically transition to the busy mode on Thursdays from 5-7PM”).

At 804, the service computing device may send the recommendation to the merchant device. The merchant device may provide the recommendation to a merchant, such as via a merchant interface. The merchant may provide input through the merchant interface regarding the recommendation (e.g., accepting or rejecting the recommendation).

At 806, the service computing device may receive a communication regarding transitioning the merchant to a mode at a future time. For example, the communication may request that the merchant be automatically set to the second mode (or another mode) at a particular time in the future (e.g., Thursdays from 5-7PM).

At 808, the service computing device may update a merchant profile associated with the merchant to indicate a transition to the mode at the future time. When the future time is reached, the service computing device may automatically set the merchant to the mode based on the merchant profile.

FIG. 9 illustrates the example process 900 to inform a courier about a delivery of an order. For ease of illustration, the process 900 is described as being performed by a service computing device, such as the computing device associated with the service provider 102.

At 902, the service computing device may receive location data for a plurality of courier devices. The service computing device may monitor locations of the plurality of courier devices over time.

At 904, the service computing device may identify a courier to deliver an order to a buyer. The operation 904 may be based on the location data for individual ones of the plurality of courier devices, locations of a merchant associated with the item, and/or a location of the buyer.

For example, a courier that is within a predetermined proximity to the merchant may be selected. At 906, the service computing device may determine a pickup time of the order at a merchant's location. For example, the service computing device may identify a preparation time that is associated with the merchant and determine a pickup time from that information. If, for instance, the merchant is associated with a busy or slammed mode, the pickup time may be an extended pickup time.

At 908, the service computing device may send a communication to a courier device associated with the identified courier to obtain the order. The communication may include information to request that the identified courier retrieve the item from the merchant and deliver the item to the buyer. For example, the communication may include the pickup time or any other information that may be useful in delivering the order.

At 910, the service computing device may receive confirmation from the courier indicating that the delivery is accepted by the courier.

At 912, the service computing device may send a communication to the merchant device. The communication may include courier information regarding the courier that has accepted delivery of the item, such as an identity of the courier, an estimated arrival time of the courier at the merchant's location, etc.

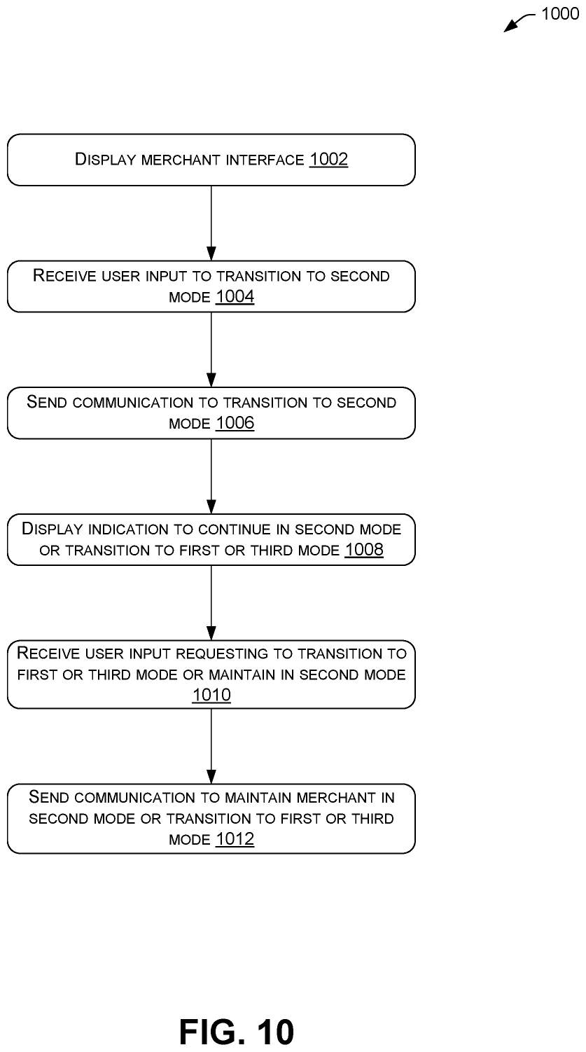

FIG. 10 illustrates the example process 1000 to enable a merchant to transition to a mode associated with a preparation time. For ease of illustration, the process 1000 is described as being performed by a merchant device, such as the merchant device 300.

At 1002, the merchant device may display a merchant interface associated with fulfilling orders for customers. The merchant interface may include a control to enable a merchant to indicate how busy the merchant is preparing orders for customers.

At 1004, the merchant device may receive user input requesting to transition from a first mode associated with less than a threshold amount of preparation activity to a second mode associated with more than the threshold amount of preparation activity.

At 1006, the merchant device may send a communication to a service computing device to transition the merchant to the second mode for a period of time.

At 1008, the merchant device may display, via the merchant interface, an indication to continue in the second mode or transition to the first mode or a third mode. The indication may be displayed upon expiration of the period of time.

At 1010, the merchant device may receive user input requesting to transition to the first or third mode or to maintain the merchant in the second mode.

At 1012, the merchant device may send a communication to the service computing device to maintain the merchant in the second mode or to transition the merchant to the first mode or third mode.

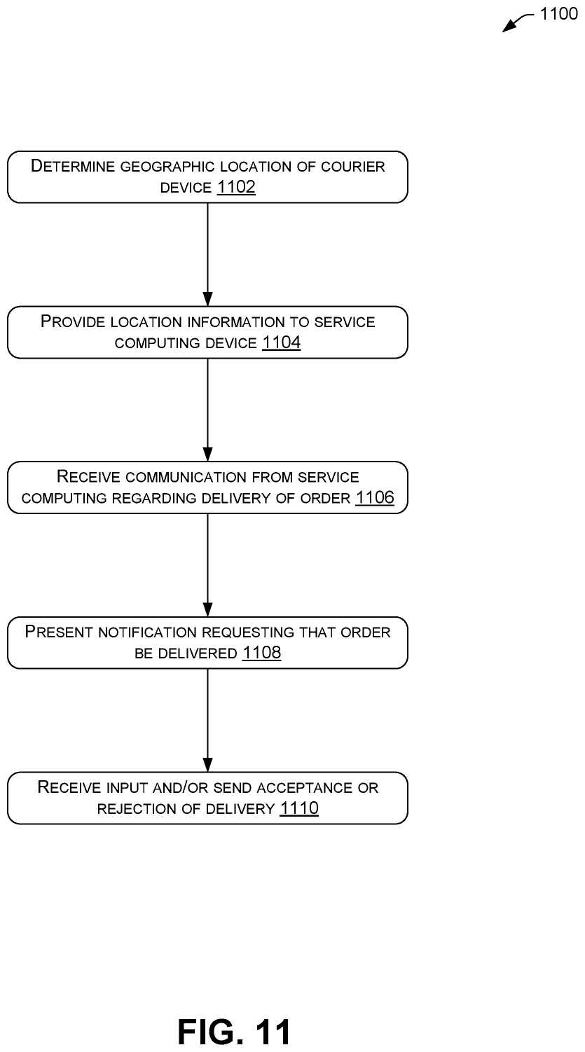

FIG. 11 illustrates the example process 1100 to enable a courier to accept or reject a delivery. For ease of illustration, the process 1100 is described as being performed by a courier device, such as the courier device 400.

At 1102, the courier device may determine a geographic location of the courier device. The geographic location may be determined based on data from a location sensor of the courier device, such as a satellite-based sensor (e.g., Global Position System (GPS), cell tower radio, wireless access point radio, wireless beacon location sensor, and so forth).

At 1104, the courier device may provide location information to a service computing device. The location information may indicate the geographic location of the courier device. The location information may be provided periodically, at a particular time, upon request, and so on.

At 1106, the courier device may receive a communication from the service computing device regarding delivery of an order. For example, the communication may include a request for a courier associated with the courier device to obtain the order from a merchant and deliver the order to a customer. The request may specify a number of items to delivery, a route of delivery, a location(s) of a merchant, a pickup time, or any other information that may be useful in making the delivery.

At 1108, the courier device may present a notification requesting that the order be delivered. The notification may be presented via a display, a speaker, and so on. In some instances, the information is displayed via a courier interface that facilitates deliveries of items (e.g., an interface that enables the courier to accept deliveries, acknowledge that deliveries have been made, request additional deliveries, etc.).

At 1110, the courier device may receive input from the courier and/or send acceptance or rejection regarding delivery of the order. For example, if the input indicates that the courier accepts a task of delivering the order to the customer, the courier device may send a communication to the service computing device indicating that such task has been accepted. Alternatively, if the input indicates that the courier rejects the delivery, the courier device may send a communication to the service computing device indicating that such task has been rejected.

Although embodiments have been described in language specific to structural features and/or methodological acts, it is to be understood that the disclosure is not necessarily limited to the specific features or acts described. Rather, the specific features and acts are disclosed herein as illustrative forms of implementing the embodiments.

1-5. (canceled)

6. A method comprising:
receiving, by a service computing device, a communication from a merchant device, the communication requesting to transition a merchant from a first mode associated with less than a threshold amount of preparation activity to a second mode associated with more than the threshold amount of preparation activity;
based at least in part on the communication, transitioning, by the service computing device, the merchant from the first mode to the second mode;
determining, by the service computing device, an extended preparation time for items offered for acquisition by the merchant based at least in part on the merchant being set to the second mode, the extended preparation time including an additional amount of time and a preparation time associated with the first mode;
using, by the service computing device, the extended preparation time during a period of time to at least one of determine an extended delivery time for offering one or more of the items for acquisition or facilitate delivery of one or more of the items;
associating, by the service computing device, respective customers with one of a plurality of customer types based at least in part on respective purchase histories of the respective customers; and
causing, by the service computing device, a first user interface for placing an order displayed on a first customer device associated with a first customer type to present a first delivery time for the items that is of shorter duration than a second delivery time for the items presented concurrently on a second user interface for placing an order on a second user device associated with a second customer type.

7. The method of claim 6, further comprising:
receiving another communication from the merchant device, the other communication requesting to transition the merchant back to the first mode;
based at least in part on the other communication, transitioning the merchant back to the first mode; and
using the preparation time associated with the first mode to at least one of offer one or more of the items for acquisition or facilitate delivery of one or more of the items.

8. The method of claim 6, further comprising:
after expiration of the period of time, receiving another communication from the merchant device, the other communication requesting to maintain the merchant in the second mode; and
based at least in part on the other communication, maintaining the merchant in the second mode for another period of time, the other period of time having the same duration as the period of time.

9. The method of claim 6, further comprising:
automatically transitioning the merchant back to the first mode upon expiration of the period of time; and
using the preparation time associated with the first mode to at least one of offer one or more of the items for acquisition or facilitate delivery of one or more of the items.

10. The method of claim 6, further comprising:
receiving merchant input for the merchant specifying the additional amount of time to add to the preparation time; and
associating the additional amount of time with a merchant profile associated with the merchant;
wherein the determining the extended preparation time includes accessing the merchant profile to determine the additional amount of time that has been specified by the merchant.

11. The method of claim 6, further comprising:
receiving merchant input for the merchant specifying a length of the period of time; and
associating the length of the period of time with a merchant profile associated with the merchant;
wherein the determining the extended preparation time includes accessing the merchant profile to determine the length of the period of time that has been specified by the merchant.

12. The method of claim 6, further comprising;
determining to transition the merchant back to the first mode; and
incrementally updating a preparation time for one or more of the items offered for acquisition by the merchant back to the preparation time associated with the first mode.

13. The method of claim 6, further comprising;
determining to transition the merchant back to the first mode;
incrementally making available multiple successive delivery times of shorter duration to customers of at least the first customer type for one or more of the items offered for acquisition by the merchant, the multiple successive delivery times being based at least in part on the preparation time associated with the first mode.

14. The method of claim 6, further comprising;
determining to transition the merchant back to the first mode; and
based at least in part on determining that that the respective purchase histories of customers of the first customer type indicate more than a threshold amount of purchases made from the merchant, making available, to the customers of the first customer type, the first delivery time of shorter duration for the items offered for acquisition by the merchant sooner than the first delivery time of shorter duration is made available to the customers of the second customer type.

15. One or more non-transitory computer-readable media storing executable instructions that, when executed by one or more processors, cause the one or more processors to perform operations comprising:
determining, by the one or more processors, to transition a merchant from a first mode associated with less than a threshold amount of preparation activity to a second mode associated with more than the threshold amount of preparation activity;
transitioning, by the one or more processors, the merchant from the first mode to the second mode;
determining, by the one or more processors, an extended preparation time for items offered for acquisition by the merchant based at least in part on the merchant being set to the second mode, the extended preparation time including an additional amount of time and a preparation time associated with the first mode;
using, by the one or more processors, the extended preparation time during a period of time to at least one of offer one or more of the items for acquisition or facilitate delivery of one or more of the items;
associating, by the one or more processors, respective customers with one of a plurality of customer types based at least in part on respective purchase histories of the respective customers; and
causing, by the one or more processors, a first user interface for placing an order displayed on a first customer device associated with a first customer type to present a first delivery time for the items that is of shorter duration than a second delivery time for the items presented concurrently on a second user interface for placing an order on a second user device associated with a second customer type.

16. The one or more non-transitory computer-readable media of claim 15, wherein the operations further comprise:
generating a report regarding transitioning the merchant to or from the second mode, the report indicating at least one of a number of times merchant input was received to set the merchant to the second mode, a number of times merchant input was received to maintain the merchant in the second mode, or an identity of an employee of the merchant that set or maintained the merchant in the second mode; and
making available the report to a merchant device.

17. The one or more non-transitory computer-readable media of claim 15, wherein the operations further comprise:
determining another extended preparation time for a previous order that has been placed with the merchant and that is in process of being delivered to a customer, the determining being based at least in part on how close in time the previous order was placed with respect to transitioning to the merchant to the second mode; and
sending another communication to a customer device associated with the customer, the other communication indicating that delivery of the previous order will be extended.

18. The one or more non-transitory computer-readable media of claim 15, wherein the operations further comprise:
based at least in part on a number of times the merchant has been previously set to or maintained in the second mode, generating a recommendation suggesting that the merchant transition to the second mode at a particular time in the future;
sending the recommendation to a merchant device associated with the merchant;
receiving another communication from the merchant device, the other communication requesting that the merchant device be automatically set to the second mode at the particular time in the future; and
automatically setting the merchant to the second mode at the particular time in the future.

19. The one or more non-transitory computer-readable media of claim 15, wherein using the extended preparation time comprises offering one or more of the items for acquisition by making available, during the period of time, an extended delivery time to customers, the extended delivery time being based at least in part on the extended preparation time.

20. The one or more non-transitory computer-readable media of claim 15, wherein the operations further comprise receiving an order for the merchant; and wherein using the extended preparation time comprises facilitating delivery of one of more of the items by:
identifying a courier to transport the order;
determining a pickup time for the order based at least in part on the extended preparation time; and
sending another communication to a courier device that is associated with the identified courier, the other communication requesting that the identified courier pickup the order from the merchant at the pickup time.

21. A system comprising:
one or more processors configured by executable instructions to perform operations comprising:
receiving, by the one or more processors, a communication from a merchant device, the communication requesting to transition a merchant from a first mode associated with less than a threshold amount of preparation activity to a second mode associated with more than the threshold amount of preparation activity;
based at least in part on the communication, transitioning, by the one or more processors, the merchant from the first mode to the second mode;
determining, by the one or more processors, an extended preparation time for items offered for acquisition by the merchant based at least in part on the merchant being set to the second mode, the extended preparation time including an additional amount of time and a preparation time associated with the first mode;
using, by the one or more processors, the extended preparation time during a period of time to at least one of determine an extended delivery time for offering one or more of the items for acquisition or facilitate delivery of one or more of the items;
associating, by the one or more processors, respective customers with one of a plurality of customer types based at least in part on respective purchase histories of the respective customers; and
causing, by the one or more processors, a first user interface for placing an order displayed on a first customer device associated with a first customer type to present a first delivery time for the items that is of shorter duration than a second delivery time for the items presented concurrently on a second user interface for placing an order on a second user device associated with a second customer type.

22. The system as recited in claim 21, the operations further comprising:
receiving another communication from the merchant device, the other communication requesting to transition the merchant back to the first mode;
based at least in part on the other communication, transitioning the merchant back to the first mode; and
using the preparation time associated with the first mode to at least one of offer one or more of the items for acquisition or facilitate delivery of one or more of the items.

23. The system as recited in claim 21, the operations further comprising:
after expiration of the period of time, receiving another communication from the merchant device, the other communication requesting to maintain the merchant in the second mode; and
based at least in part on the other communication, maintaining the merchant in the second mode for another period of time, the other period of time having the same duration as the period of time.

24. The system as recited in claim 21, the operations further comprising:
automatically transitioning the merchant back to the first mode upon expiration of the period of time; and
using the preparation time associated with the first mode to at least one of offer one or more of the items for acquisition or facilitate delivery of one or more of the items.

25. The system as recited in claim 21, the operations further comprising:
receiving merchant input for the merchant specifying the additional amount of time to add to the preparation time; and
associating the additional amount of time with a merchant profile associated with the merchant;
wherein the determining the extended preparation time includes accessing the merchant profile to determine the additional amount of time that has been specified by the merchant.
